(19) United States
(12) Patent Application Publication
(10) Pub. No.: US 2012/0050010 A1
(43) Pub. Date: Mar. 1, 2012

(54) Restricting the Operation of a Motor Vehicle

(76) Inventor: Michael Anthony Largue, Berry Edge (GB)

(21) Appl. No.: 13/215,318

(22) Filed: Aug. 23, 2011

(30) Foreign Application Priority Data
Aug. 27, 2010 (GB) 10 14 307.1

(51) Int. Cl. G06F 7/04; H04N 7/18

(52) U.S. Cl. 340/5.72; 348/77; 340/5.83; 348/E07.085

(57) ABSTRACT

A camera (402) is provided for receiving a candidate image of a portion of a driver's upper limb, such as a palm, emphasising patterns of blood transferring pathways, such as veins, within the exposed portion of the driver's palm. A candidate image is compared with stored template images (411) and an output device is configured to produce a first output, possibly allowing the vehicle to start, if the candidate image matches a stored template image. The device is configured to produce a second output if the candidate image does not match a stored template image. This second output may disable operation of the vehicle and/or raise an alarm.

### CROSS REFERENCE TO RELATED APPLICATIONS

This application claims priority from United Kingdom patent application No 10 14 307.1, filed Aug. 27, 2010, the whole contents of which are included herein by way of reference.

### BACKGROUND OF THE INVENTION

1. Field of the Invention

The present invention relates to apparatus for restricting the operation of a motor vehicle.

2. Description of the Related Art

Traditionally, access to motor vehicles and the operation of motor vehicles has been restricted by the use of physical keys used to open a door and to start the ignition. In commercial fleets of vehicles, specific drivers may be given keys for particular vehicles but it is relatively easy for these keys to be exchanged so that an alternative driver would be in a position to drive a vehicle without authorization. Although this constitutes fraudulent use of the vehicle, on many occasions it is difficult for this use to be prevented. Such unauthorised use is becoming increasingly undesirable not only in terms of additional operational costs but also in terms of creating liabilities for the fleet owner. Thus, were an accident to occur during non-authorised use, it is likely that the unauthorised user would not be covered by the fleet owner's insurance policy but the fleet owner could be held liable to a third party.

### BRIEF SUMMARY OF THE INVENTION

According to an aspect of the present invention, there is provided apparatus for restricting the operation of a motor vehicle, comprising: a camera for receiving a candidate image of a portion of a driver's palm emphasising patterns of blood transferring pathways within said portion of said driver's palm; a comparing device for comparing said candidate image with one or more stored template images; and an output device configured to produce a first output signal if the candidate image matches a stored template image and configured to produce a second output signal if the candidate image does not match a stored template image.

In an embodiment, the apparatus includes a device for emitting infra-red light, wherein said blood transferring pathways are subcutaneous veins.

According to a second aspect of the invention, there is provided a method of restricting the operation of a motor vehicle, comprising the steps of: receiving a candidate image of a portion of a driver's palm emphasising the patterns of blood transfer and pathways within said portion of said driver's palm; comparing said candidate image with one or more stored template images; producing and enabling output signal if the candidate image matches a stored template image; and restricting operation of the vehicle until the generation of said enabling output signal.

In an embodiment, the method further comprises the steps of bringing a palm of one hand (right or left) into the field of view of a camera to initiate normal operation of a motor vehicle and bringing the alternative palm (left or right) into the field of view of said camera to initiate a modified operation of the motor vehicle.

According to a third aspect of the present invention there is providing a solid-state data storage device having a dataset of image templates derived from images of a pre-determined portion of palms of authorised drivers stored thereon, wherein: said data set is transferred to apparatus for restricting the operation of a motor vehicle, in which an image taken of a portion of a driver's palm is compared with said data set so as to allow or prevent operation of the vehicle.

### BRIEF DESCRIPTION OF THE SEVERAL VIEWS OF THE DRAWINGS

FIG. 1 shows a motor vehicle with installed apparatus embodying the present invention;

FIG. 2 shows a portion of the installed apparatus;

FIG. 3 shows an alternative operation of the installed apparatus of FIG. 2;

FIG. 4 details the installed apparatus, including a processing system;

FIG. 5 shows operations performed by the processing system identified in FIG. 4; and,

FIG. 6 represents a state diagram for the installed apparatus.

### DETAILED DESCRIPTION OF THE PREFERRED EMBODIMENTS

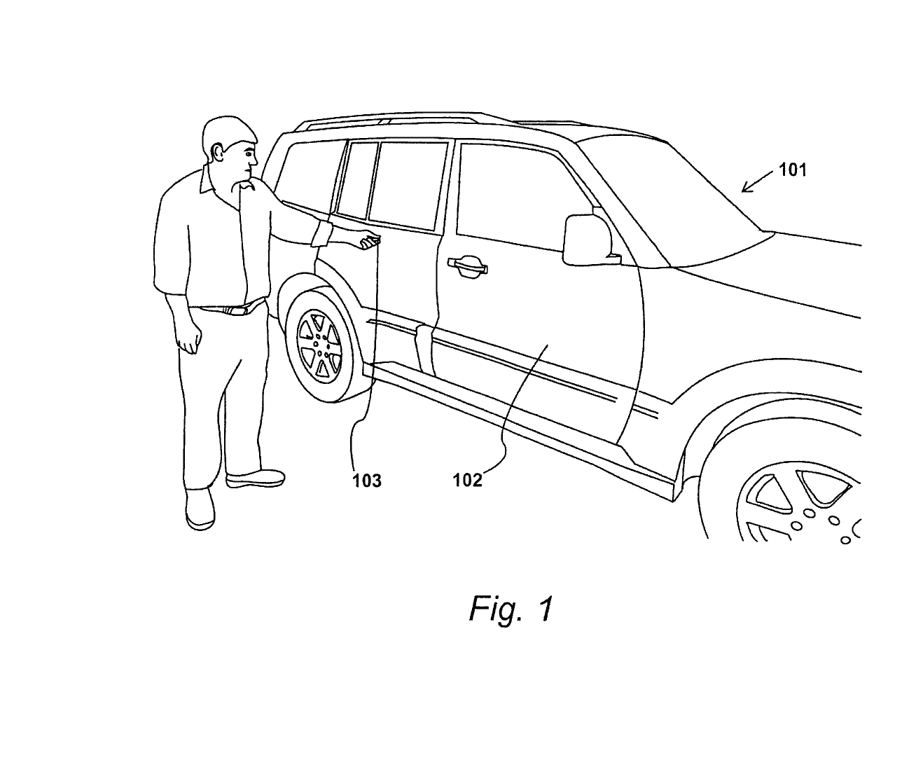

FIG. 1

A motor vehicle 101 is shown in FIG. 1 that has installed therein apparatus for restricting the operation of the motor vehicle. When parked and locked, the apparatus enters a dormant mode, thereby minimising power consumption. However, upon taking measures to unlock the vehicle and enter the vehicle, the installed apparatus is interrupted and subsequently performs operations to determine whether the driver has been authorised to drive and operate the vehicle.

In the example of FIG. 1, door 102 is unlocked by the operation of a remote infrared device 103. In an alternative embodiment, the subsequent opening of door 102 will result in the activation of an interior courtesy light. Thus, it is possible to provide a light detection device in close proximity to the courtesy light, which again can be used to trigger and interrupt the installed apparatus.

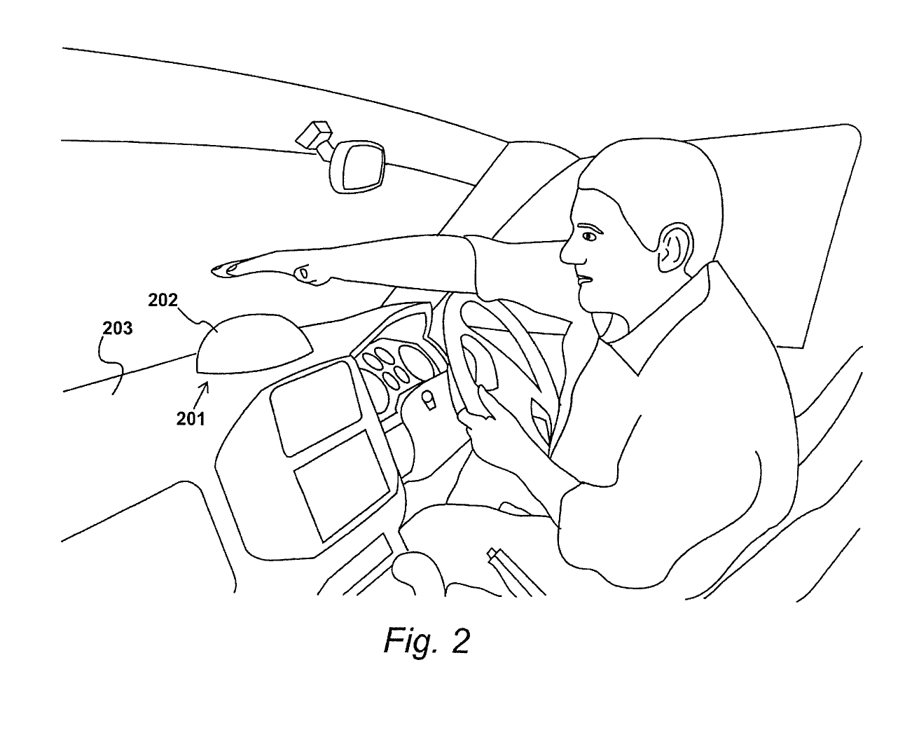

FIG. 2

A portion 201 of the installed apparatus is illustrated in FIG. 2. A protective dome 202 mounted on dashboard 203 includes a camera for receiving a candidate image of a portion of a driver's palm emphasising patterns of blood transferring pathways within this portion of the driver's palm. In this example, the blood transferring pathways are veins such that the camera is sensitive to images produced by the transfer of deoxygenated blood in the subcutaneous veins on the driver's palm.

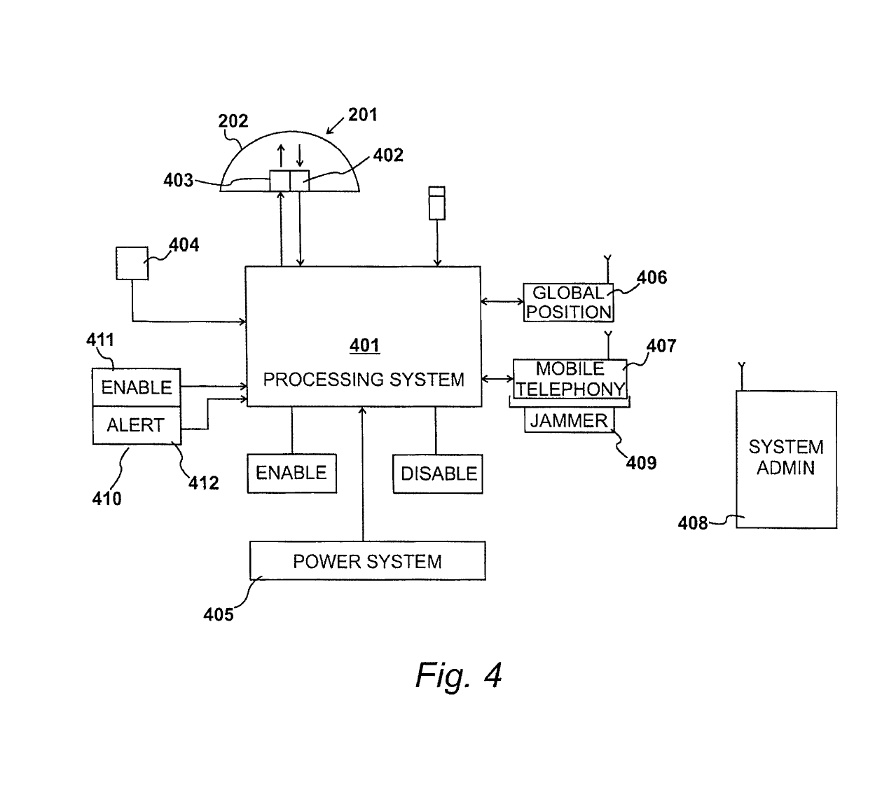

As described in greater detail with reference to FIG. 4, the installed apparatus also includes a comparing device for comparing candidate images with one or more stored approved template images. An output device is configured to generate an enabling output signal if the candidate image matches one of the approved template images but operation of the vehicle is restricted until this enabling output signal has been generated. In this way, the individual driver is identified and the vehicle only becomes operational if the identified driver is authorised to drive the vehicle.

Use of the palm has many advantages including the fact that the palm is usually hair free and therefore this potential obstacle is eliminated.

The sensing technology used in the embodiment for vein patterns is based on near-infrared spectroscopy (NIRS); that is the vein pattern in a subcutaneous tissue of the palm captured using near-infrared light.

The blood conveys oxygen by means of haemoglobin in which the haemoglobin becomes oxygenated when oxygen attaches to it at the lungs and then becomes deoxygenated when the oxygen is lost at peripheral vessels in the body. Thus, the arteries contain oxygenated haemoglobin and the veins contain deoxygenated haemoglobin. These two types of haemoglobin have different absorption spectra and deoxygenated haemoglobin absorbs light having a wavelength of 760 nm (nano-meter), which is within the near infrared area. When capturing a portion of the body using near-infrared light, the vessels will appear darker than other parts because the vessels absorb more of this wavelength.

In the images produced by this technique, the shadows of the veins lying near the surface can be seen but those lying deep within the body cannot be seen. Typically, veins of 1 mm diameter can be seen to a depth of about 3 mm using a wavelength of 880 nm. Thus, in an embodiment, wavelengths between 750 nm and 890 nm may be deployed.

In addition to the comparing device comparing the candidate image with one or more stored approved template images, it is possible in an embodiment for the comparing device to also compare the candidate image with one or more alerting template images. Furthermore, the output device is configured to produce an alerting output signal if the candidate image matches one of the alerting template images.

In an embodiment, approved template images may be produced by imaging the right palms of approved drivers and alerting templates may be produced by scanning the left palm of approved drivers, or vice versa.

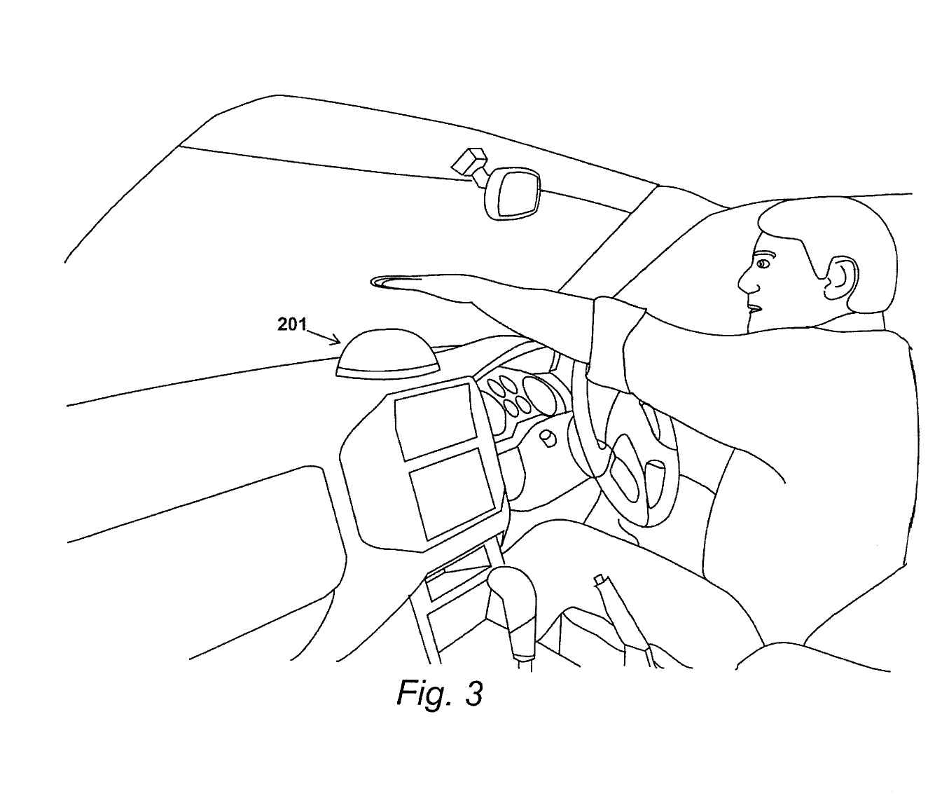

FIG. 3

As illustrated in FIG. 3, should the driver be placed in a condition of distress, for example a highjack situation, the driver could deploy their left palm over device 201, as illustrated in FIG. 3 which could result in the vehicle being activated such that the vehicle is then operational. However further measures could be taken, such as the issuing of a message to a control center and the facilitation of the opening of an audio channel from the motor vehicle to a receiving station. In this way, the vehicle could be tracked in its distressed state and the situation quickly brought to the attention of the police.

FIG. 4

Installed apparatus is detailed in FIG. 4, in which processing system 401 communicates with scanning device 201. The scanning device or sensor 201 includes a protective dome 202 and within this dome there is a camera 402 and a plurality of light emitting diodes (LEDs) 403. The light emitting diodes allow the subject's palm to be scanned over 115 degrees and in the embodiment a total of four near-infrared spectroscopy LED's may be provided. Thus, the driver's palm is illuminated with infrared light and an image is captured by camera 202 showing vein patterns within the drivers palm. LED devices 403 are activated in response to a signal received from the processing system 401 and digital images are received at processing system 401 from the camera 402. in an embodiment, a driver may hover their hand over the sensor without making physical contact with cover 202.

The processing system 401 may be in a sleep mode initially and it is interrupted from this mode via an interrupt signal generated by a detection device 404. Thus, this detection device could detect the interior courtesy lights being activated or it could respond to a door-opening signal from a remote device.

Processing system 401 receives power from a dedicated power supply 405. In an embodiment, power supply 405 provides up to five years of service and is charged from the alternator provided within the vehicle. In this way, power is not taken from the vehicle's resident battery and furthermore the power supply for this system is less susceptible to being damaged in attempts to steal the vehicle.

In an embodiment, the system is integrated with an electric control unit resident within the majority of vehicles providing digital communication within the vehicle over a cam-bus. The system also facilitates the introduction of a tracker device for enhanced security. In an embodiment, the introduced apparatus does not attempt to replace existing technology but is designed to work with it.

In an embodiment, the device includes a global positioning system 406 such that it is possible to determine the geographical position of the vehicle as part of a navigational system or as part of a tracking system. Furthermore, in an embodiment, it is possible for the processing system to be programmed with the locations of particular service locations such that the disabling activities of the installed system are themselves disabled when the vehicle is taken to one of these locations. Thus, during servicing, it would be possible for the vehicle to be started and operated in a conventional manner and a disabling feature, of the present invention, would be reintroduced upon taking the vehicle away from the specified zone. These zones could be pre-programmed or in an alternative embodiment, temporary zones could be defined by the reception of digital messages.

To facilitate the transmission of data to and from the system, a mobile telephony system 407, possibly operating in accordance with GSM or GPRS, is provided in an embodiment. Mobile telephony module 407 may also be used for routine communications with the system administration station 408 and for making communications when alert conditions are identified in response to a distress situation occurring.

A button may be provided within the vehicle which allows the vehicle to be switched off and possibly switched back on again but only when confined within a specified zone as previously described. In normal operation, if the vehicle stalls, it can be restarted only by using the sensor again.

In an embodiment, the mobile telephony module 407 includes a frequency jamming device 409 to minimise the risk of communication channels within the system being intercepted by a third party. Thus, access to the mobile telephony system 407 by external devices can be prevented.

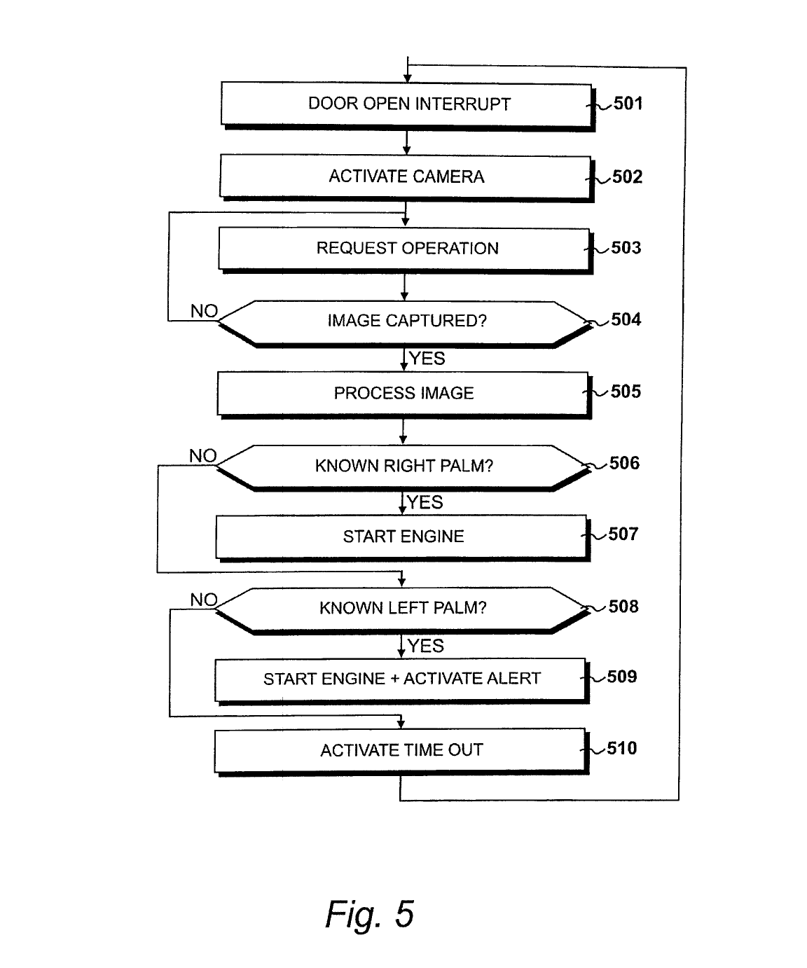

It is possible for the processing system to operate under program control, an example of which is described with reference to FIG. 5, and the program instructions may be stored in non-volatile memory so as to reduce start up time significantly. However, although established within a software environment, it may be stated that the installed apparatus is effectively embedded and it is undesirable for third parties to be given operating system access.

A further storage device 410 stores the image templates. Storage device 410 may take the form of a removable solid state storage device such as a USB key. The stored data includes approved templates 411 and alert templates 412. In an embodiment, the approved templates may be derived from images of right palms of approved drivers, with the alert templates being derived from the left palms of the same authorised drivers.

FIG. 5

Operations performed by the processing system 401 are detailed in FIG. 5. Initially, the system is interrupted by the door opening operation at step 501. In response to being interrupted, the camera 402 is activated at step 502 and the light emitting diode devices 403 are also activated. Thus, the detection system 201 is now in a position to receive images.

At step 503 a request for input data is made and an appropriate indication is provided to a driver. Thus, system 201 may include a collection of light emitting diode devices. A red device for example could indicate that a palm image is required. An amber light could indicate that a palm has been detected but is not being held in the correct position to enable an appropriate image capture to take place. Thereafter, having relocated the position of the palm, a green LED could indicate that an image capture has taken place.

Thus, at step 504 a question is asked as to whether an image has been captured and if answered in the negative further requests are made at step 503. Until an image has been captured, operation of the vehicle remains disabled.

Having received image data, the image data is processed at step 505 by comparing the image data against the stored templates. This processing stage may be initiated by modifying and enhancing the image data itself so as to facilitate the comparison process.

The candidate image data is compared against the enabling image templates 411. For each stored template a question is asked as to whether a candidate is an image of a known right (or left) palm. When answered in the affirmative the engine is started at step 507. When all of the templates have been considered the question asked at step 506 is finally answered in the negative. A question is then asked at step 508 as to whether the candidate image is that of a known left (or right) palm. On this occasion, comparisons are made with the alert templates 412. If a match is found and the question asked at step 508 is answered in the affirmative, the engine starts in a similar manner to that described before but in addition an alert is activated.

Having considered all of the alert template images without a match being found, the question asked at step 508 will be answered in the negative and it is then assumed that an image has been derived from a non-authorised driver. In an embodiment, it will be possible for the system to effectively do nothing and return to step 501. However, in an alternative embodiment, a timeout condition is activated at step 510. The period of this timeout may be selected and may, for example, be a duration of 10 minutes. During this timeout period the system becomes non-functional and it is not possible for a further palm image to be considered. After the timeout period the system resets and control returns to step 501.

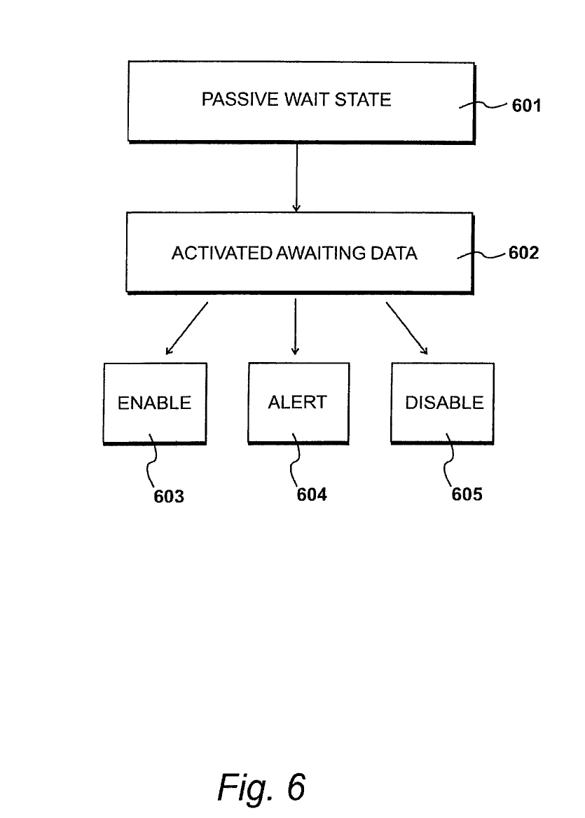

FIG. 6

It can be appreciated that the system described with respect to FIGS. 4 and 5 may be represented as a state machine, as illustrated in FIG. 6.

Initially, the system is in a passive wait state 601 and remains in this state until interrupted.

When interrupted, the system enters state 602 in which the system is activated but is awaiting data.

On detecting an authorised right palm image, the system enters an enabled state 603 during which the vehicle starts and from thereon it is as if the vehicle had been started in a convention manner.

Upon detecting an authorised left palm image, the system enters an alert state 604. In this alert state the engine starts but further actions are taken in order to notify an administration station to the effect that the driver is experiencing a distressed situation.

If an image is obtained from a non-authorised driver, the system enters a disabled state 605 where it is possible for the system to be effectively reset allowing an alternative driver to seek authentication immediately. Alternatively, in the disabled state 605, it is possible that a timeout situation is generated. Furthermore, if several attempts are made over a relatively short period of time, it is possible for the timeout period to be increased each time. Furthermore, it would also be possible for the system to communicate with the system administrator on the basis that a non-authorised driver were attempting to make use of the vehicle.

1. Apparatus installed within a motor vehicle and configured to restrict the operation of said motor vehicle, comprising:
a camera for receiving a candidate image of a portion of a driver's palm emphasising patterns of blood transferring pathways within said portion of said driver's palm;
a comparing device for comparing said candidate image with one or more stored approved template images; and
an output device configured to generate an enabling output signal if the candidate image matches one of said approved template images, wherein
operation of the vehicle is restricted until the generation of said enabling output signal.

2. The apparatus of claim 1, including a device for emitting infra-red light, wherein said blood transferring pathways are subcutaneous veins.

3. The apparatus of claim 1, wherein said comparing device compares the candidate image with one or more alerting template images and
said output device is configured to produce an alerting output signal if the candidate image matches one of said alerting template images.

4. The apparatus of claim 3, further configured to issue a message to a control centre and facilitate the opening of an audio channel from said motor vehicle to a receiving station in response to the generation of said alerting output signal.

5. The apparatus of claim 1, wherein said camera is mounted within a housing and said housing includes one or more illumination devices.

6. The apparatus of claim 5, wherein said one or more illumination devices emit infra red light and veins carrying de-oxygenated blood are detected.

7. The apparatus of claim 5, wherein said housing includes indicators to indicate that the portion of said driver's upper limb has been correctly located in the field of view of the camera.

8. The apparatus of claim 1, wherein the vehicle has a door for allowing a driver to gain access to the vehicle and said comparing device is energised when an action is taken to open said door.

9. The apparatus of claim 1, wherein said camera and said comparing device are disabled to allow conventional operation of the vehicle when the vehicle is located at one or more specified geographical locations.

10. A method of restricting the operation of a motor vehicle, comprising the steps of:
receiving a candidate image of a portion of a driver's palm emphasising patterns of blood transfer and pathways within said portion of said driver's palm;
comparing said candidate image with one or more stored template images;
producing an enabling output signal if the candidate image matches a stored template image; and
restricting operation of the vehicle until the generation of said enabling output signal.

11. The method of claim 10, further comprising the steps of bringing a palm of one hand (right or left) into the field of view of a camera to initiate normal operation of a motor vehicle and bringing the alternative palm (left or right) into the field of view of said camera to initiate a modified operation of the motor vehicle.

12. The method of claim 11, wherein said modified operation of the motor vehicle involves raising an alarm.

13. The method of claim 12, wherein said alarm is raised by issuing a message to a control centre and facilitating the opening of an audio channel from said motor vehicle to a receiving station.

14. A solid state data storage device having a data set of image templates derived from images of a predetermined portion of palms of authorised drivers stored thereon, wherein:
said data set is transferred to apparatus for restricting the operation of a motor vehicle, in which an image taken of a portion of a driver's palm is compared with said data set so as to allow or prevent operation of the vehicle.

15. The solid state data storage device of claim 14, wherein said apparatus for restricting the operation of the motor vehicle includes a camera that is mounted within a housing which also includes one or more illumination devices.

16. The solid state data storage device of claim 15, wherein said illumination devices emit infrared light.

17. The solid state data storage device of claim 15, wherein said housing includes indicators to indicate that the portion of said drivers upper limb has been correctly located in the field of view of the camera.

18. The solid state data storage device of claim 14, wherein the vehicle has a door for allowing the driver to gain access to the vehicle and processing devices for reading said data set of image template in energised when action is taken to open said door.
